(19) United States
(12) Patent Application Publication
(10) Pub. No.: US 2014/0320992 A1
(43) Pub. Date: Oct. 30, 2014

(54) Edge-sealed mirror and a method for its manufacture

(71) Applicants: Volker Denkmann, Kempen (DE); Wilhelm Schenkel, Grevenbroich (DE); Andreas Siemen, Juchen (DE); Ulrich Hampel, Grevenbroich (DE); Sandra Eberhard, Juchen (DE)

(72) Inventors: Volker Denkmann, Kempen (DE); Wilhelm Schenkel, Grevenbroich (DE); Andreas Siemen, Juchen (DE); Ulrich Hampel, Grevenbroich (DE); Sandra Eberhard, Juchen (DE)

(73) Assignee: Hydro Aluminium Rolled Products GmbH, Grevenbroich (DE)

(21) Appl. No.: 14/327,636

(22) Filed: Jul. 10, 2014

Related U.S. Application Data
(63) Continuation of application No. PCT/EP2013/050114, filed on Jan. 4, 2013.

(30) Foreign Application Priority Data
Jan. 13, 2012 (DE) 102012100293.2

(51) Int. Cl. G02B 5/08; B29C 65/08

(52) U.S. Cl. CPC G02B 5/0866; B29C 65/085
USPC 359/883; 156/73.5; 156/555; 156/510

(57) ABSTRACT

The invention relates to a mirror comprising a reflective surface formed from a composite of a reflective film and a substrate, wherein the reflective film is disposed on the substrate and comprises at least one polymer layer and a metal layer disposed underneath the at least one polymer layer. It is the requirement of the invention to propose a mirror which can be manufactured in a simple way and at the same time comprises an improved corrosion behaviour. According to a first teaching of the present invention the stated requirement is met in that a sealing seam is provided for corrosion protection at least in certain areas, the sealing seam being formed by bonding the polymer layer to the substrate in a material-locking manner, wherein the metal layer is interrupted in the area of the sealing seam.

### CROSS-REFERENCE TO RELATED PATENT APPLICATIONS

This patent application is a continuation of PCT/EP2013/050114, filed Jan. 4, 2013, which claims priority to German Application No. 10 2012 100 293.2, filed Jan. 13, 2012, the entire teachings and disclosure of which are incorporated herein by reference thereto.

### FIELD OF THE INVENTION

The invention relates to a mirror comprising a reflective surface formed from a composite of a reflective film and a substrate, wherein the reflective film is disposed on the substrate and comprises at least one polymer layer as well as a metallic layer disposed underneath the at least one polymer layer. In addition, the invention relates to a method for manufacturing such a mirror as well as a device for carrying out the method.

### BACKGROUND OF THE INVENTION

Regenerative energy is produced in solar power installations which encompass a large number of large-scale mirrors. Due to the immensely large total of reflective surfaces required for solar power installations, vaporised reflective surfaces made from glass do not appear to be economically viable. Therefore, in order to provide these mirrors in an economically viable manner, one has to revert to a particularly simple process. One measure for providing reflective surfaces consists in laminating a substrate normally comprised of a metal sheet such as of steel, aluminium or an aluminium alloy, onto a reflective film. The reflective film consists of a polymer layer which, for example, consists of a PMMA plastic and is characterised by its very high transparency. The reverse of the polymer layer may be a metal layer, preferably a silver layer sputtered onto it, which has a thickness in the nanometre range, for example. In addition, two metal layers can also be used, such as a first silver layer which has an additional copper layer sputtered onto it. The metal layer, in particular the silver layer, is characterised by extremely high reflectivity allowing reflective films with very high reflectivity to be manufactured. If these are laminated, for example, onto an aluminium sheet, steel sheet or steel band, low-cost reflective surfaces are obtained. The substrate may, of course, also be a composite material which again consists of a polymer. The mirrors of a solar power installation are very much exposed to the vagaries of weather. In particular the silver layer, which is important for reflectivity, tends to corrode with the result that the corroded areas loose much of their reflectivity and become “blind”, thereby loosing their usefulness as reflective surfaces.

Therefore, various methods have been employed in the past to protect the edges of such mirrors against corrosion. For example, an adhesive tape has been used as edge protection, which was applied to the edges subsequently or during manufacture of the mirror. This adhesive tape or another sealing material such as varnish around the edges or the use of a silicon sealing material, was meant to prevent moisture from penetrating between the polymer layer and the metal layer, in particular the silver layer. For it is well known that penetrating moisture causes corrosion in the metal layer resulting in the mirror becoming blind. In particular due to the capillary effect, corrosion continues to spread across the entire reflective surface so that the entire reflective surface deteriorates within a short space of time. Any previously taken anti-corrosion measures for the protection of mirrors have been expensive and at the same time, have given rise to problems during prolonged application.

### SUMMARY OF THE INVENTION

It is therefore the requirement of the invention to propose a mirror which can be manufactured in a simple way and, at the same time, exhibits improved corrosion behaviour. In addition, a method for manufacturing such a mirror as well as a device for carrying out the method shall be proposed.

According to a first teaching of the present invention the stated requirement is met in that a sealing seam is provided for corrosion protection, at least in certain areas, which is formed by bonding the polymer layer to the substrate in a material-locking manner, wherein the metal layer is interrupted in the area of the sealing seam.

The sealing seam of the mirror according to the invention, therefore, consists of an area in which the metal layer, in particular the silver layer, is interrupted and the polymer layer is bonded to the substrate in a material-locking manner. The material-locked bond between the polymer layer disposed above the metal layer and the substrate makes it possible, for example, that the metal layer remaining in the reflective surface is hermetically separated from the edge regions of the mirror without any corrosion-promoting moisture being able to penetrate through the sealing seam. Salt-spray tests have shown that the reflective surfaces which were completely enclosed by the sealing seams constructed according to the invention did not tend to corrode or to become “blind”.

According to a first design of the mirror according to the invention the sealing seam is an ultrasonic weld. Ultrasonic welding makes it possible to carefully bond the polymer layer to the substrate whilst at the same time to cut through the silver layer disposed underneath the polymer layer. This is also true in the case where an additional copper layer is provided, which for example is disposed underneath the silver layer for its protection.

A particularly low-cost manufacture of large reflective surfaces permits a next design of the mirror according to the invention in that the mirror is shaped like a band and along its longitudinal edges comprises at least one sealing seam extending in longitudinal direction of the band. This permits a band-shaped mirror already sealed along its longitudinal edges to be provided, which can be cut to size on site, for example, and can then be sealed, for example manually along the additionally created edges. But it is also feasible for the band-shaped mirror with sealed longitudinal edges to be processed into blanks which are then automatically provided with one or more additional, for example transverse, sealing seams.

If according to a next embodiment of the mirror the reflective film comprises a polymer layer of PMMA, it is possible to use a plastic layer particularly suitable for ultrasonic welding and a highly transparent plastic as a carrier material for the reflecting metal or silver layer and to allow the manufactured mirror to be provided with sealing seams in a very easy way.

According to a further design of the mirror several parallel sealing seams are provided. Several parallel sealing seams, for example a dual seam, have, albeit, an increased areal requirement, but redundancy is also increased, if the metal layer in one sealing seam has not been completely cut through.

If according to a next embodiment of the mirror the substrate is a metal or a composite material of a hardness higher than the polymer layer, the sealing seam can be produced in a simply way, since ultrasonic welding does not affect the substrate and only the polymer layer is bonded to the substrate. Therefore, suitable substrates are steel, aluminium or aluminium alloys or plastic composite materials of increased hardness. Preferred aluminium alloys are AlMg1, AlMg1Mn1 or aluminium magnesium alloys with a higher alloy content, since thinner and lighter versions of these can already provide the required stability. The thicknesses of substrates consisting of an aluminium alloy lie, for example, between 0.4 mm and 1.5 mm. Typical low-cost bands of aluminium alloys with good processing and very good stability characteristics in relation to the use as mirrors comprise bands from aluminium alloys of type AA 3005 and AA 3105 for the thicknesses quoted.

According to a second teaching of the present invention the requirement stated for a method for manufacturing a mirror consisting of a composite of reflective film and substrate, in which the substrate is laminated to a reflective film which comprises at least one polymer layer and a metal layer disposed underneath the polymer layer, is met in that following laminating, a sealing seam is produced on the mirror, wherein production of the sealing seam is effected by laminating the polymer layer onto the substrate in a material-locking manner, wherein the metal layer is interrupted in the areas of the sealing seam.

As already explained above, the inventors have recognised that an interruption of the silver layer has the effect of preventing the corrosion processes, in an area of the silver layer, from invading other areas of the silver layer and thus from clouding the reflective surface. A particularly good sealing effect at the interruption point of the silver layer is achieved if the polymer layer is bonded to the substrate in a material-locking manner, thereby utilising this bond as a moisture barrier.

Preferably, the sealing seam is produced by ultrasonic welding, wherein on the one hand, the ultrasonic sonotrodes cause the polymer layer to become melted-on and on the other hand, the metal layer is undone in the area of the sealing seam by selective contact pressure and altogether interrupted. Ultrasonic welding is a very safe method of connecting the polymer layer with the substrate, whilst at the same time interrupting the metal layer. In addition, ultrasonic welding is extremely locally limited preventing any adjacent areas of the mirror from being affected.

According to a first design of the method according to the invention the substrate and the reflective film are shaped as a band, the reflective film is continuously laminated onto the band-shaped substrate, and the mirror manufactured in this way is wound onto a coil, wherein sealing of the longitudinal edges of the band-shaped mirror is effected either inline together with laminating the reflective film, or by renewed unwinding of the mirror from the coil in an additional manufacturing step. Preferably, the sealing seams are produced inline on the band-shaped mirror, since no subsequent process step is required for sealing the longitudinal edges of the band-shaped mirror. In this case, but also in the case that the coil with the band-shaped mirror is unwound once more, the longitudinal edges are sealed by continuously sealing the edge regions, for example by ultrasonic welding. The method used is called a “roll-to-roll” method.

A so-called “roll-to-sheet” method is provided according to a further design, in that the substrate is band-shaped and divided into areal substrate blanks, in that the reflective film is then bonded onto the substrate blanks and the substrate blanks with bonded-on reflective film are provided, at least on the longitudinal edges, with at least one sealing seam, respectively. In this way mirror blanks with already sealed longitudinal edges can be provided, which subsequently can be provided with a sealing seam transversely to the sealing seams in longitudinal direction. In particular this offers the possibility of immediately adapting the blanks to the respective mirror size of the mirror to be manufactured and of automatically providing them with transverse sealing seams. In this case completely sealed mirrors can be offered.

It has become evident that the sealing seams can be produced by ultrasonic welding with especially high speed, using ultrasonic roller sonotrodes and optional anvil rollers. Ultrasonic roller sonotrodes as well as the optional anvil rollers used as counter holders are employed in particular then, when linearly extending sealing seams are produced.

Preferably, the ultrasonic roller sonotrode geometry comprises a radius of 1.0 mm-3.00 mm, preferably 1.5 mm-2.5 mm. Due to the corresponding ultrasonic roller sonotrode geometry it is ensured that the polymer layer is bonded in a material-locking manner to the substrate with the metal layer being completely interrupted at the same time in the area of the sealing seam. For it has become evident that for larger radii the interruption of the metal layer was not sufficiently reliable. If radii smaller than 1.0 mm are used, there is a danger that with material-locked laminating the substrate becomes damaged.

In addition, it has become evident that sufficient process-reliable sealing can be achieved with a sealing seam produced at a contact pressure of 1-6 MPa, a frequency of 20-60 kHz and an amplitude of the ultrasonic sonotrode of between 25 and 70 μm. The said parameters have proved to be very process-reliable resulting in very tight sealing seams and thus in excellent protection against corrosion of the reflective surface. At the same time sufficiently high processing speeds could be achieved which permit economic production of the sealed mirrors consisting of a reflective film and a substrate.

Finally, the requirement stated above is met by a device for manufacturing a mirror comprising a decoiler for a band-shaped substrate, a laminating device for laminating the band-shaped reflective film onto a band-shaped substrate as well as at least two ultrasonic roller sonotrodes which are disposed, respectively, in the region of the opposing longitudinal edges of the band-shaped substrate and downstream of the laminating device and which are provided for sealing the band-shaped mirror along the longitudinal edges, wherein additionally a coiler is provided to winding the edge-sealed mirror. The device just described permits a roll-to-roll process for manufacturing an edge-sealed band-shaped mirror. This process is particularly economic. The band-shaped mirror can be cut to size as input material at the location of the solar power installation and be provided, as required, with a further sealing seam for enclosing the reflective surface as such. Moreover, it is feasible with the device according to the invention to provide anvil rollers as a means for producing counter pressure against the ultrasonic roller sonotrodes, in order to avoid any adverse mechanical impact upon the band-shaped substrate during sealing of the longitudinal edges.

According to a next design of the device a cutting device is provided for the substrate downstream of the decoiler which cuts the substrate into blanks before or after the laminating process, and instead of the coiler a depositing device is provided for the mirror blanks. Using the device just described and starting with a band-shaped substrate, for example an aluminium alloy band, cut-to-size mirrors with sealing seams along the longitudinal edges may be provided, which are already adapted for their intended purpose or cut-to-size and need to be provided merely with a transverse sealing seam, in order to completely protect the reflective surface from corrosive influences. The transverse sealing seams may, for example, be produced automatically in a subsequent process step. Using the device just described a so-called “roll-to-sheet” process can be realised.

Finally, the device can be further adapted in that instead of the decoiler, a receptacle for cut-to-size substrates and a feed for these to go the laminating and sealing stations is provided. This implementation of the device according to the invention permits a “sheet-to-sheet” process, i.e. the manufacture of a plate-shaped mirror with sealing seams along its longitudinal edges, starting with a plate-shaped substrate.

### BRIEF DESCRIPTION OF THE DRAWINGS

The invention will now be described in detail by way of embodiments in conjunction with the drawing, in which

FIGS. 1a) and 1b) schematically show the construction of an exemplary embodiment of a mirror consisting of a composite of a reflective film and a substrate,

FIG. 2, in a schematic sectional view, shows an exemplary embodiment for producing a sealing seam for a mirror according to FIG. 1b),

FIG. 3 shows a further exemplary embodiment of a band-shaped mirror,

FIGS. 4a) and 4b) show a top view of two further exemplary embodiments of a mirror,

FIG. 5, in a schematic perspective view, shows how the sealing seams are produced on the exemplary embodiment of FIG. 3,

FIG. 6, in a schematic view, shows an exemplary embodiment of a device for manufacturing a mirror by the “roll-to-roll” process,

FIG. 7, in a schematic view, shows an exemplary embodiment of a device for manufacturing a mirror by the “roll-to-sheet” process, and

FIG. 8, in a schematic view, shows an exemplary embodiment of a device for manufacturing a mirror by the “sheet-to-sheet” process.

### DETAILED DESCRIPTION OF THE INVENTION

FIG. 1a) shows the principal construction of a mirror consisting of a reflective film 1 and a substrate 2. The reflective film 1 preferably comprises a polymer layer 3 and a metal layer 4. Optionally, the reflective film 1, as shown in the present embodiment, comprises an adhesive layer 5 allowing the reflective film 1 to be laminated to the substrate 2. The substrate 2, as already explained, may consist of a metal such as steel, aluminium or an aluminium alloy or of a composite material which comprises a hardness higher than the polymer layer 3 of the reflective film. If, for example, an aluminium alloy, preferably an aluminium alloy of type AA3005 or AA3105 is used, the substrate normally has a thickness of 0.1-2 mm, preferably 0.4-1.3 mm. Optionally, the substrate may comprise a conversion layer not shown in FIGS. 1a) and 1b), in order to passivate the surface of for example an aluminium alloy band and to optimise it for applying the reflective film. Chemical passivation of the surface of an aluminium alloy band is, in particular, of advantage if the metal layer responsible for reflecting the light comprises a copper layer in addition to the normally provided silver layer, which is provided between silver layer and substrate. In principle there is further the possibility of additionally or alternatively arranging an adhesive layer 5 on the substrate 2 prior to laminating or bonding.

From the two individual materials of the reflective film 1 and the substrate 2, a mirror 7, in particular a composite mirror, is manufactured by bonding or laminating, such as shown in a schematic sectional view in FIG. 1b). The dimensions of the individual layers in relation to each other are not true to scale in the drawing, since in particular the metal layer 4, for example a silver layer, has a thickness of merely a few nanometres. The transparent polymer layer 3 by comparison, is distinctly thicker. The thickness of the polymer layer 3 lies in the micrometre range. If a mirror constructed in this way is exposed to moisture, the moisture penetrates via the edges 6 of the mirror in the metal layer 4 from the outside to the inside. If the metal layer 4 consists, for example, of a silver layer, this leads to corrosion and, in the worst case, to delamination of the transparent polymer layer 3. The corrosion leads to an extreme reduction in reflectivity of the metal layer 4 or the mirror 7, resulting in the mirror 7 loosing its mirroring properties. In other words, the mirror goes blind.

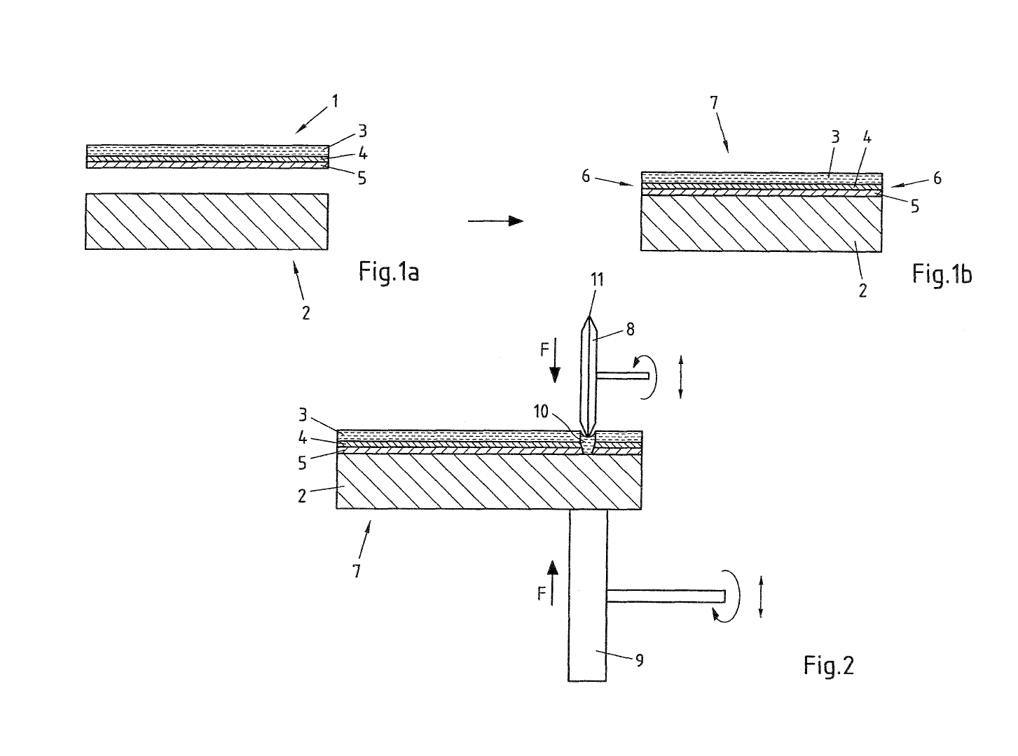

FIG. 2, in a schematic sectional view, shows an embodiment for the production of a sealing seam preventing the corrosion and thus the mirror 7 from going blind. The polymer layer 3 of the band-shaped mirror 7, which preferably consists of a PMMA plastic, is welded to the substrate 2 using an ultrasonic roller sonotrode 8 and an anvil roller 9 in such a way that the metal layer is completely interrupted in the area of the sealing seam 10. As can be recognised in FIG. 2, a material-locked bond is produced between the polymer layer 3 and the substrate. This has the effect that moisture penetrating from the outside into the edges 6 is stopped directly at the sealing seam 10 to an extent where the reflective surfaces enclosed by the corresponding sealing seam 10 have remained free from corrosion for several weeks when subjected to a salt spray test, and completely intact. It has become evident that the reflective surfaces can be process-reliably sealed very effectively by ultrasonic welding of the polymer layer 3 to the substrate 2. To this end the ultrasonic roller sonotrode 8 preferably comprises a radius 11 of 1.0 mm-3.0 mm, especially preferably 1.5 mm-2.5 mm. But it is also possible to use the anvil roller 9 shown in FIG. 2 as an ultrasonic roller sonotrode and to achieve the contour of the sealing seam 10 with the aid of an anvil roller provided with an appropriate radius, which roller then does not perform any ultrasonic oscillations itself.

Preferably, both the anvil roller 9 and the ultrasonic roller sonotrode 8 are driven by a drive in such a way that these perform a rolling movement at the same speed as the band. In addition, both the ultrasonic roller sonotrode 8 and the anvil roller 9 must be pressed against each other at a certain contact pressure, in order to produce a sealing seam with an interruption of the metal layer 4. In the present embodiment with a PMMA polymer layer 3 and an aluminium alloy substrate 2 from an aluminium alloy of type AA3105, contact pressures of 2-4 bars were sufficient in order to produce a sealing seam in a process-reliable manner. During tests it also became evident that the chosen geometry of the ultrasonic sonotrode or the anvil roller can affect the quality of the sealing seam 10. Thus, the use of a radius of 8.5 mm independently of the set contact pressures or the set ultrasonic output, did not produce a sufficiently tight sealing seam 10. In the tests the ultrasonic frequency used was 20 kHz with an amplitude of 40 μm for the ultrasonic roller sonotrodes and an output of 500 W. The results of the corresponding tests are shown in table 1.

| | | | Contact | |
|---|---|---|---|---|
| | Radius | | pressure | |
| | ultrasonic | | ultrasonic | Result of |
| | roller | | roller | salt spray |
| | sonotrode | | sonotrode | test after |
| Test | (mm) | Output | (MPa) | 10 weeks |
| V1 | 8.5 | 33% | 0.6 | −− |
| V2 | 8.5 | 33% | 2 | −− |
| V3 | 8.5 | 33% | 6 | −− |
| V4 | 8.5 | 100% | 6 | −− |
| V5 | 1.5 | 100% | 2 | ++ |
| V6 | 2.5 | 100% | 4 | ++ |

The tests V1 to V4 showed that in the salt spray test corrosion of the silver layer occurred below the polymer layer leading to poor marks (−−) being given to the result. Tests V5 and V6, by contrast, did not show any corrosion at all and, therefore, were given very good marks (++).

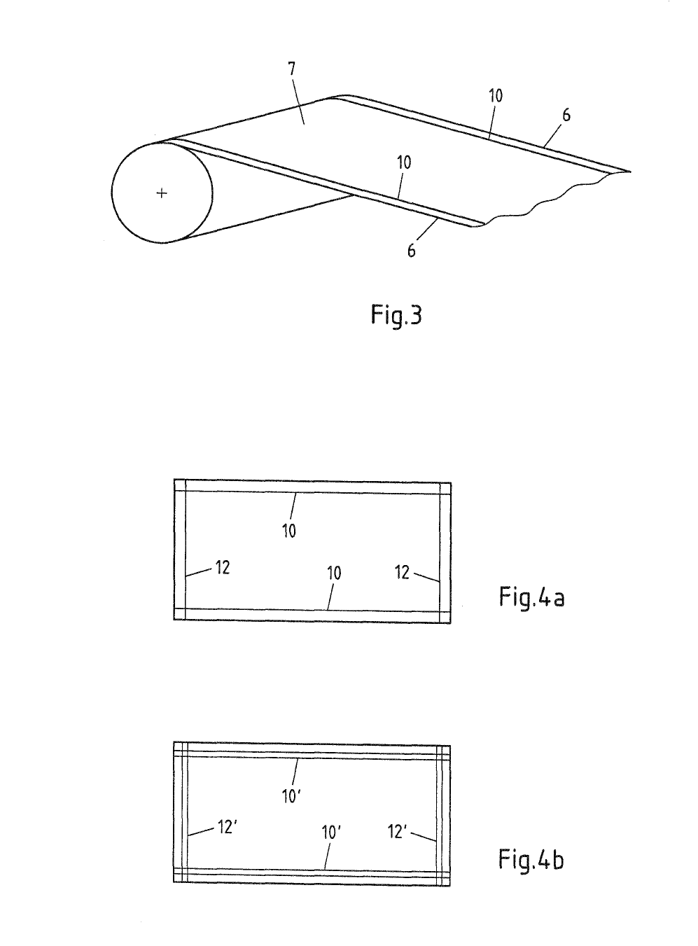

FIG. 3 shows a perspective view of a band-shaped mirror 7 according to a further embodiment. The band-shaped mirror 7 comprises two sealing seams 10 which are arranged respectively in the region of edges 6 of the band-shaped mirror 7. The band-shaped mirror 7 can be wound to form a coil as shown in FIG. 3 and used for manufacturing completely sealed mirrors specifically cut to suit to the application. The band-shaped mirror 7 permits a particularly economic manufacture of correspondingly cut mirror elements.

Corresponding mirror elements are illustrated in FIGS. 4a) and 4b) in a top view. FIG. 4a) shows an embodiment of a mirror manufactured from a band-shaped mirror 7, which is cut rectangularly and, apart from the sealing seams 10 provided on the longitudinal edges and produced during manufacture of the band-shaped mirror 7, comprises transverse sealing seams 12. The additionally provided transverse sealing seams 12 may be produced in an identical way, as shown in FIG. 2. It is of course feasible that the sealing seams 10 extending along the longitudinal edges of the mirror are produced on a cut-to-size sheet and, thus, are produced discontinuously. The sealing seams 10, 12 can also be produced using a manual device. An indexing process is also possible in order to allow shaped edges, i.e. not only linearly extending edge regions to be sealed.

If the shape of a double hump with two radii is chosen for the geometry of the ultrasonic roller sonotrode or the anvil roller, a double sealing seam 11′ or 12′ can be produced, for example in longitudinal direction or even in transverse direction to the longitudinal extent of the mirror, such as shown in FIG. 4b). A double sealing seam 11′, 12′ additionally increases reliability of preventing the mirror from going blind, in case a leak is present in an area of a sealing seam.

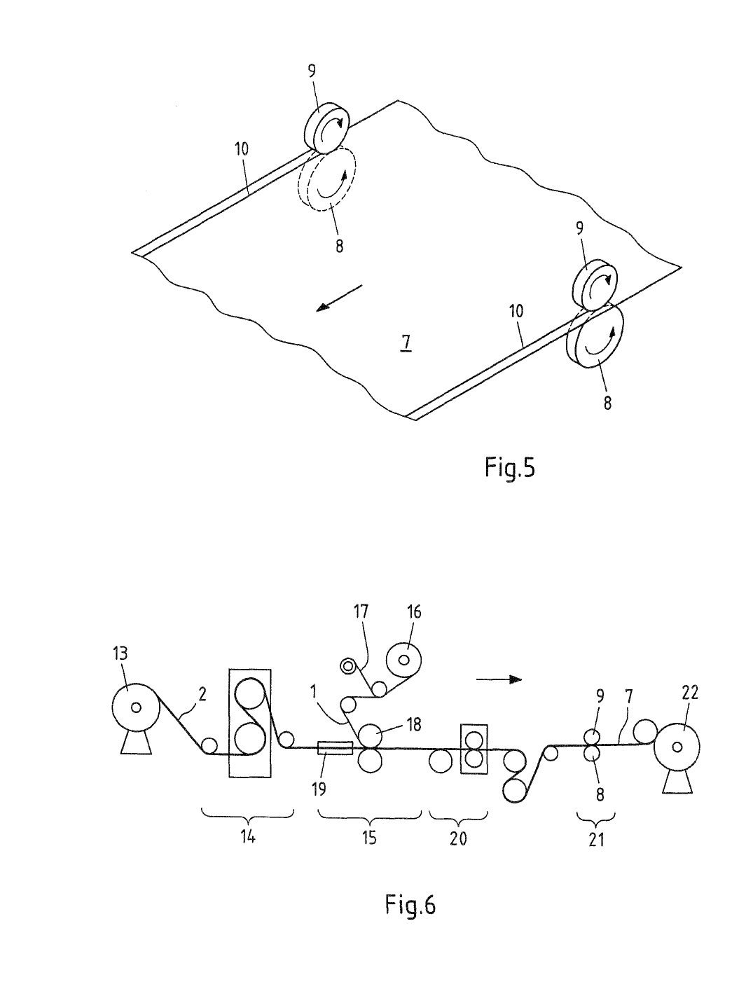

FIG. 5), in a schematic perspective view, shows an embodiment of how to manufacture a band-shaped mirror 7 with sealing seams 10 on its longitudinal edges. In the embodiment shown in FIG. 5) the ultrasonic roller sonotrode is positioned on the underside of the band, i.e. on the side of the substrate, whereas the anvil roller 9 is arranged on the side of the polymer layer 3. In contrast to the embodiment shown in FIG. 2) the positions of the ultrasonic roller sonotrode and the anvil roller are reversed, wherein the anvil roller comprises the respective radius of 1.0 mm-3.0 mm. This is another way of producing a very good quality sealing seam.

Corresponding constructions are also depicted in FIGS. 6, 7 and 8. FIG. 6 shows an embodiment of a device for executing a “roll-to-roll” process for manufacturing a band-shaped mirror 7 with sealing seams in the longitudinal edge regions. The process starts at a decoiler 13 holding the substrate, for example an aluminium alloy band consisting of an aluminium alloy of type AA 3005 or AA 3105 in form of a coil. The band-shaped substrate is fed via a guide roller geometry 14 to a laminating device 15 which, on a coil 16, comprises the reflective film 1 provided with a protective film 17. The protective film 17 has been applied to the adhesive layer and permits easy handling of the reflective film 1 wound as a coil. The reflective film 1 is laminated to the substrate 2, which is preferably a band from an aluminium alloy of type AA3005 or AA3105 which was previously optionally heated in a heating device 19, with the aid of the laminating rolls 18 and the application of pressure and heat. The composite produced in this way and composed of the reflective film 1 and the substrate 2 is fed via a cooling roll device 20 to a device for producing a sealing seam 21, consisting of an anvil roller 9 and an ultrasonic roller sonotrode 8. Subsequently, the band-shaped mirror 7 now comprising two sealing seams along its longitudinal edges is wound into a coil 22. It is easy to imagine that this manufacturing process is economic and highly productive. The coil prepared in this way of a band-shaped mirror 7 with sealing seams along its longitudinal edges may be cut to size in a further process step to produce the desired reflective surfaces and may be provided with corresponding additional sealing seams, resulting in a reflective surface which is protected against corrosion by sealing seams 10, 12 on its entire circumference.

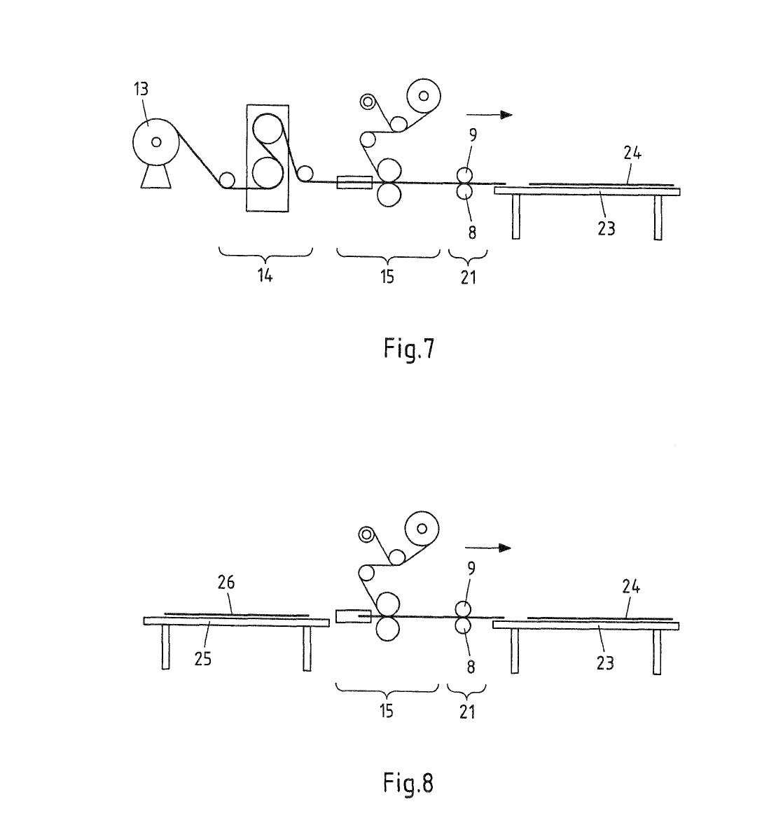

Alternatively, the cutting process to produce the required reflective surfaces may be performed directly following production of the sealing seams 10 along the longitudinal edges 6 of the band-shaped mirror 7. An embodiment for performing a respective “roll-to-sheet” process is shown in FIG. 7. Compared to FIG. 6 a device 21 for producing the sealing seams 10, which consists of an anvil roller 9 and an ultrasonic roller sonotrode 8, is provided directly downstream of the laminating device 15. Following production of the sealing seams 10, the band-shaped mirror 7 arriving on the depositing table 23 is cut to form blanks 24. The blank-cutting device is, however, not shown in FIG. 7. From the depositing table the cut-to-size mirror 24 can be fed to further processing steps, for example for producing the transverse sealing seams 12 or 12′.

In FIG. 8 finally a further embodiment of a device for performing a “sheet-to-sheet” process is shown, in which, compared to the embodiments in FIG. 6 and FIG. 7, a reception table 25 instead of the decoiler is used for receiving plate-shaped cut-to-size substrates 26, which are then laminated onto the reflective film 1 in a laminating device 15 and equipped with longitudinal sealing seams 10 using the device 21. The reflective surfaces provided with sealing seams 10 along the longitudinal edges are deposited on a depositing table 23 and conveyed further to further processing steps, in particular for producing transverse sealing seams.

1. A mirror comprising a reflective surface which is formed of a composite from a reflective film and a substrate, wherein the reflective film is disposed on the substrate and comprises at least one polymer layer and a metal layer disposed underneath the at least one polymer layer, wherein at least one sealing seam is provided for corrosion protection at least in certain areas, which sealing seam is formed by bonding the polymer layer to the substrate in a material-locking manner, wherein the metal layer is interrupted in the area of the sealing seam, wherein the sealing seam is an ultrasonic weld.

2. The mirror according to claim 1, wherein the mirror is band-shaped and comprises at least one sealing seam extending, respectively, along the longitudinal edges in longitudinal direction of the band.

3. The mirror according to claim 1, wherein the reflective film comprises a polymer layer from a polymethyl methacrylate (PMMA).

4. The mirror according to claim 1, wherein several sealing seams extending in parallel are provided.

5. The mirror according to claim 1, wherein the substrate is a metal or a composite material with a hardness higher than that of the polymer layer.

6. A method for manufacturing a mirror having a composite of reflective film and substrate according to claim 1, in which the substrate is laminated to a reflective film comprising at least one polymer layer and a metal layer disposed underneath the polymer layer, wherein following laminating, a sealing seam is produced on the mirror, wherein the sealing seam is produced by bonding the polymer layer to the substrate in a material-locking manner, wherein the metal layer is interrupted in the areas of the sealing seam, and wherein the sealing seam is produced by ultrasonic welding.

7. The method according to claim 6, wherein the substrate and the reflective film are band-shaped, the reflective film is laminated continuously to the band-shaped substrate and the mirror produced in this way is wound onto a coil, wherein sealing of the longitudinal edges of the band-shaped mirror by means of sealing seams is effected either inline together with laminating the reflective film or by renewed unwinding of the mirror from the coil in an additional process step.

8. The method according to claim 6, wherein the substrate is band-shaped and divided into areal substrate blanks, the reflective film is laminated onto the substrate blanks and the substrate blanks with the laminated-on reflective film are provided, at least along the longitudinal edges, with at least one sealing seam, respectively.

9. The method according to claim 6, wherein the sealing seams are produced by ultrasonic welding using ultrasonic roller sonotrodes and optional anvil rollers.

10. The method according to claim 9, wherein the ultrasonic roller sonotrodes comprise a radius of 1.0 mm-3.0 mm.

11. The method according to claim 9, wherein the contact pressure is between 1 MPa and 6 MPa, the frequency is 20 to 60 kHz and the amplitude is between 25 and 70 μm.

12. A device for manufacturing a mirror according to claim 1, comprising a decoiler for a band-shaped substrate, a laminating device for laminating the band-shaped reflective film onto the band-shaped substrate as well as at least two ultrasonic roller sonotrodes, which are arranged, respectively, in the region of the opposing longitudinal edges of the band-shaped substrate and downstream of the laminating device, allowing them to be used for sealing the band-shaped mirror along the longitudinal edges by an ultrasonic weld seam, wherein a coiler is additionally provided for winding the edge-sealed mirror.

13. The device according to claim 12, wherein a blank-cutting device is provided downstream of the decoiler for the substrate, which blank-cutting device cuts the substrate before or after the laminating process into blanks, and a depositing table is provided instead of the coiler for the cut-to-size mirrors.

14. A device for manufacturing a mirror according to claim 1, comprising a receptacle for cut-to-size substrates and a feed for feeding the same for laminating and sealing, a laminating device for laminating the band-shaped reflective film onto the cut-to-size substrate as well as at least two ultrasonic roller sonotrodes, which are arranged, respectively, in the region of the opposing longitudinal edges of the cut-to-size substrate and downstream of the laminating device, allowing them to be used for sealing the band-shaped mirror along the longitudinal edges by an ultrasonic weld seam.
